(19) United States
(12) Patent Application Publication
(10) Pub. No.: US 2011/0067685 A1
(43) Pub. Date: Mar. 24, 2011

(54) Gas-Fueled Food Cooker with a Sealed Heating Conduit

(76) Inventor: Robert L. Myers, Homer, LA (US)

(21) Appl. No.: 12/888,679

(22) Filed: Sep. 23, 2010

Related U.S. Application Data
(60) Provisional application No. 61/272,442, filed on Sep. 23, 2009.

(51) Int. Cl. A47J 37/07

(52) U.S. Cl. 126/25 R

(57) ABSTRACT

A cooker for preparing food. In some embodiments, the cooker includes a cooking chamber and a heating conduit extending through the cooking chamber. The heating conduit has an enclosed combustion chamber.

### CROSS-REFERENCE TO RELATED APPLICATIONS

This application claims benefit of U.S. provisional application Ser. No. 61/272,442 filed Sep. 23, 2009, and entitled “Sealed Gas Heating Source For Gas Fired Food Cookers,” which is hereby incorporated herein by reference in its entirety for all purposes.

### STATEMENT REGARDING FEDERALLY SPONSORED RESEARCH OR DEVELOPMENT

Not applicable.

### BACKGROUND

This disclosure relates generally to a gas-fueled food cooker, such as an outdoor gas grill. More particularly, the disclosure relates to a food cooker having an enclosed heating conduit.

Gas grills are commonly used to prepare food outdoors. Typically the gas grill includes a grill body, or bottom tray, and a grill hood, which together form a cooking chamber. One or more cook grids are supported within the cooking chamber to create a cooking surface. At least one burner is disposed within the cooking chamber beneath the cooking surface. Each burner includes a plurality of burner ports. When the gas grill is operational, an air-fuel mixture exits the burner ports and is ignited to create flame, which is the source of heat for cooking.

During operation of the gas grill, food is placed on the cooking surface and manually moved or turned from time to time until ready. As the food is moved on the cooking surface, the open flame below it creates a safety hazard to the cook. Further, the food is exposed to exhaust fumes created by the flame, which may adversely affect the taste of the food. As the food cooks, drippings from the food, such as grease, fall onto the burners below. Over time, the drippings cause corrosion of the burners until they must be replaced.

Accordingly, there is a need for a heat source that eliminates the risk to safety posed by the open flame inside a gas grill and the exposure of food to exhaust fumes during cooking. It would be particularly desirable if the heating source were more resistive to corrosion than conventional burners.

### SUMMARY OF THE PREFERRED EMBODIMENTS

A cooker for preparing food is disclosed. In some embodiments, the cooker includes a cooking chamber and a heating conduit extending through the cooking chamber. The heating conduit has an enclosed combustion chamber.

In some embodiments, the cooker includes a cooking chamber, a heating conduit, and a fuel source. The heating conduit extends through the cooking chamber and has an enclosed combustion chamber and a fuel inlet in fluid communication with the fuel source.

In some embodiments, the cooker includes a cooking chamber and a heating conduit. The heating conduit has a first portion and a second portion. The first portion extends through the cooking chamber and has an enclosed combustion chamber. The second portion is external to the cooking chamber and has a fuel inlet and an air inlet.

Thus, embodiments described herein comprise a combination of features and advantages intended to address various shortcomings associated with conventional gas grills. The various characteristics described above, as well as other features, will be readily apparent to those skilled in the art upon reading the following detailed description of the preferred embodiments, and by referring to the accompanying drawings.

### BRIEF DESCRIPTION OF THE DRAWINGS

For a detailed description of the disclosed embodiments, reference will now be made to the accompanying drawings in which:

FIG. 1 is front view of a gas-fueled food cooker in accordance with various principles disclosed herein;

FIG. 2 is front view of the gas-fueled food cooker of FIG. 1 with the grill hood open, exposing to view the cook grids and cooking surface;

FIG. 3 is an enlarged view of the cook grids of FIG. 2;

FIG. 4 is an enlarged view of the heating conduits of FIG. 3;

FIG. 5 is a schematic representation of one heating conduit of FIG. 1; and

FIG. 6 is a perspective view of the fuel supply assembly of FIG. 1.

### DETAILED DESCRIPTION OF THE DISCLOSED EMBODIMENTS

The following description is directed to exemplary embodiments of gas-fueled food cookers. The embodiments disclosed should not be interpreted, or otherwise used, as limiting the scope of the disclosure, including the claims. One skilled in the art will understand that the following description has broad application, and that the discussion is meant only to be exemplary of the described embodiments, and not intended to suggest that the scope of the disclosure, including the claims, is limited to those embodiments.

Certain terms are used throughout the following description and claims to refer to particular features or components. As one skilled in the art will appreciate, different persons may refer to the same feature or component by different names. This document does not intend to distinguish between components or features that differ in name but not function. Moreover, the drawing figures are not necessarily to scale. Certain features and components described herein may be shown exaggerated in scale or in somewhat schematic form, and some details of conventional elements may not be shown in interest of clarity and conciseness.

In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct connection. Thus, if a first device couples to a second device, that connection may be through a direct connection, or through an indirect connection via other devices and connections.

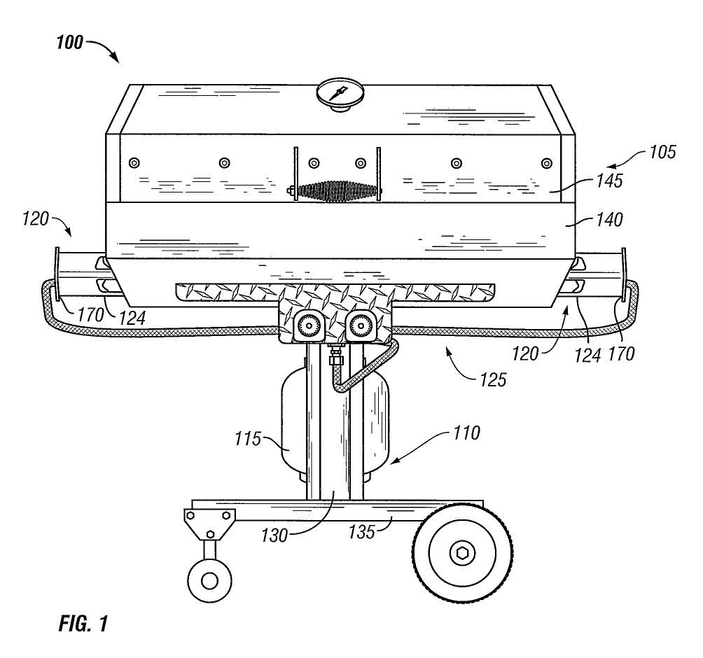

Referring now to FIG. 1, there is shown an embodiment of a gas-fueled food cooker in accordance with the principles disclosed herein. Gas-fueled food cooker 100 includes a cooking chamber 105, a support frame 110, a fuel source 115, two heating conduits 120, and a fuel supply assembly 125. Frame 110 supports cooking chamber 105 at a convenient height above the ground. In this exemplary embodiment, support frame 110 includes a support post 130 coupled between the base of cooking chamber 105 and a wheeled frame 135. Wheeled frame 135 enables mobility of food cooker 100. In other embodiments, support frame 110 may include only support post 130, and further support post 130 may be permanently mounted in the ground, for instance, proximate an edge of a patio. In such cases, food cooker 100 is immobile.

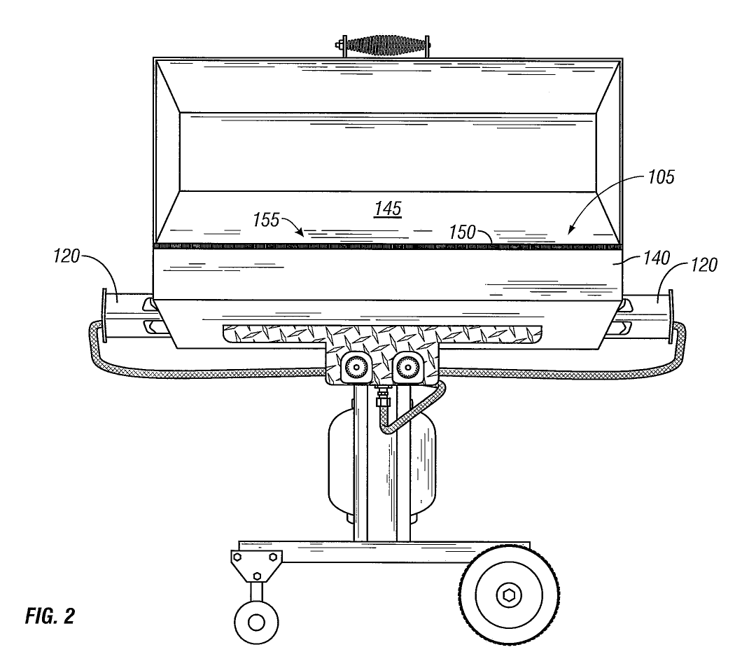

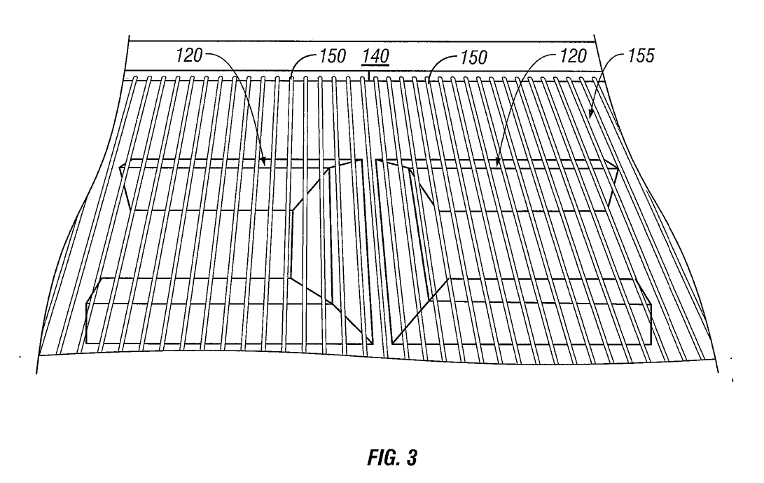

Cooking chamber 105 is formed by a grill body 140 and a grill hood 145 coupled thereto. Grill hood 145 is pivotable relative to grill body 140 between a closed position and an open position. In the closed position, shown in FIG. 1, grill hood 145 abuts grill body 140, and cooking chamber 105 is enclosed. In the open position, shown in FIG. 2, grill hood 145 does not abut grill body 140, and cooking chamber 105 is accessible. As best viewed in FIG. 3, food cooker 100 further includes two cook grids 150 disposed within cooking chamber 105. Cook grids 150 are accessible when grill hood 145 is in the open position. Further, cook grids 150 are disposed above heating conduits 120 and form a cooking surface 155 upon which food is placed for cooking.

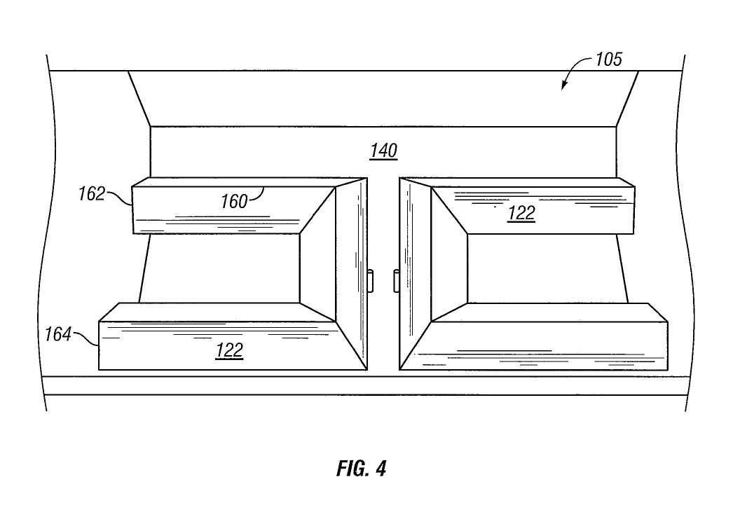

Referring now to FIG. 1 and FIG. 4, in which cook grids 150 are removed, each heating conduit 120 is supported by grill body 140 and extends through cooking chamber 105. The heating conduit 120 is welded, or otherwise coupled, to grill body 140 such that a portion 122 of the heating conduit 120 is disposed within cooking chamber 105 and another portion 124 of the heating conduit 120 is disposed outside of cooking chamber 105. The portion 122 of heating conduit 120 disposed within cooking chamber 105, or interior portion 122 of heating conduit 120, is best viewed in FIG. 4. The portion 124 of heating conduit 120 disposed outside of cooking conduit 105, or exterior portion 124 of heating conduit 120, is best viewed in FIG. 1.

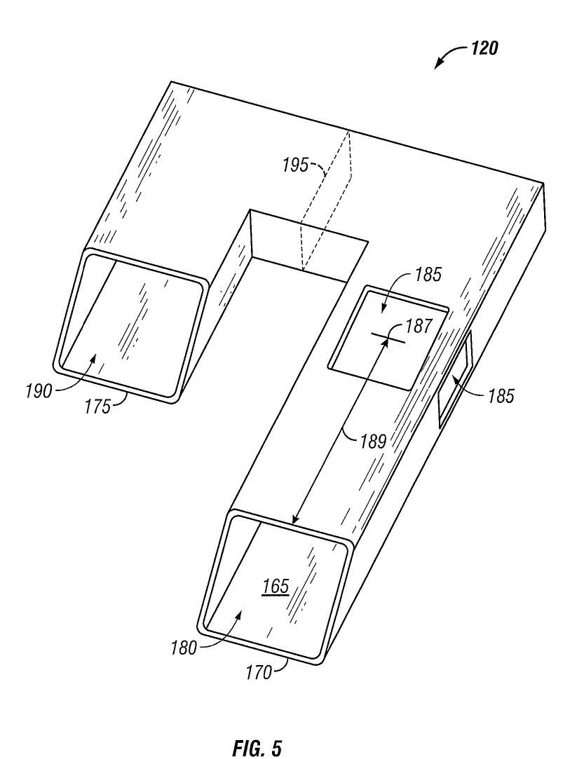

Turning to FIG. 5, which is a schematic representation of the heating conduit 120, the heating conduit 120 is a tubular and has an internal combustion chamber 165 extending between a first end 170 (see also FIG. 1) and a second end 175. Heating conduit 120 has a fuel inlet 180 at first end 150. Fuel is introduced into combustion chamber 165 through inlet 180, as will be described. Heating conduit 120 further includes one or more air inlets 185 spaced apart from fuel inlet 180. In the illustrated embodiment, air inlets 185 are rectangular in shape. However, in other embodiments, air inlets 185 may be differently shaped. Fuel and air inlets 180, 185 are disposed in exterior portion 124 of heating conduit 120. As such, fuel and air inlets 180, 185 are external to cooking chamber 105.

Air is introduced into combustion chamber 165 through inlets 185. In preferred embodiments, air passively flows through inlets 185 into combustion chamber 165. Inside combustion chamber 165, the air combines with fuel therein to form an air-fuel mixture that is subsequently ignited. Due to the pressure of fuel supplied by fuel source 115, the air-fuel mixture flows through heating conduit 120 as the air-fuel mixture burns within combustion chamber 165. At second end 175, heating conduit 120 has an exhaust outlet 190. Exhaust outlet 190 is substantially flush with the exterior surface of grill body 140. Fumes created by combustion of the air-fuel mixture within heating conduit 120 are exhausted from heating conduit 120 through exhaust outlet 190 to the atmosphere surrounding food cooker 100.

Air inlets 185 are positioned relative to fuel inlet 180 such that the center 187 of each air inlet 185 is a distance 189, as measured along the longitudinal axis of heating conduit 120, from fuel inlet 180. In preferred embodiments, distance 189 equals 4 1/32 inches, the cross-sectional area of fuel inlet 180 is 7.65 square inches, and the sum of the cross-sectional areas of all air inlets 185 is 9.96 square inches. The preferred dimensions enable an optimum air-fuel mixture.

As best viewed in FIG. 4, heating conduit 120 is coupled to grill body 140 along a first attachment edge 162 and along a second attachment edge 164. Interior portion 122 of heating conduit 120 has a length 160. Length 160 is the distance between first attachment edge 162 and second attachment edge 164 as measured along the longitudinal axis of heating conduit 120.

Length 160 of heating conduit 120 is selected to provide a substantially uniform heat flux rate to cooking surface 155 (FIG. 3). Depending on the size of cook grids 150, this may require that heating conduits 120 extend the length of cook grids 150 and back again, as shown in FIG. 3. Providing a uniform rate of heating to cooking surface 155 enables food placed thereon to cook efficiently and consistently, regardless of its position on cooking surface 155. Furthermore, length 160 is selected such that the fuel contained in the air-fuel mixture within combustion chamber 165 is substantially consumed before reaching second end 175 of heating conduit 120. This enables fuel introduced at inlet 180 to be completely combusted, and the associated heat produced utilized for cooking purposes, rather than exhausted from outlet 190 and wasted.

Heating conduit 120 has a cross-sectional area 195 defined normal to length 160. In the illustrated embodiment, cross-sectional area 195 is rectangular in shape. In other embodiments, heating conduit 120 may be configured such that cross-sectional area 195 has another shape, such as but not limited to circular, square, or oval.

The interior portions 122 of heating conduits 120 are sealed. As such, combustion chambers 165 of heating conduits 120 are enclosed. As used herein, the expression “enclosed combustion chamber” means that there is no gas flow path between combustion chamber 165 and the portion of cooking chamber 105 surrounding heating conduits 120, and that the flames within heating conduits 120 are inaccessible through cooking chamber 105. Consequently, the flames are inaccessible to a cook during operation of food cooker 100. Moreover, fumes created by combustion of the air-fuel mixture within combustion chambers 165 are prevented from escaping combustion chambers 165 into the interior of cooking chamber 105 surrounding heating conduits 120. Instead, the fumes exhaust from heating conduits 120 through exhaust outlet 190. Hence, food placed on cook grids 150 is not exposed to the fumes during operation of food cooker 100.

Fuel source 115 is coupled to fuel inlet 180 by fuel supply assembly 125. Source 115 provides fuel for heating or cooking of food placed on cook grids 150. In the illustrated embodiment, fuel source 115 is a tank containing fuel, such as but not limited to natural gas or liquid propane. Tank 115 is releasably coupled to and supported by wheeled frame 135. In other embodiments, fuel source 115 may be an in-ground propane tank or natural gas line.

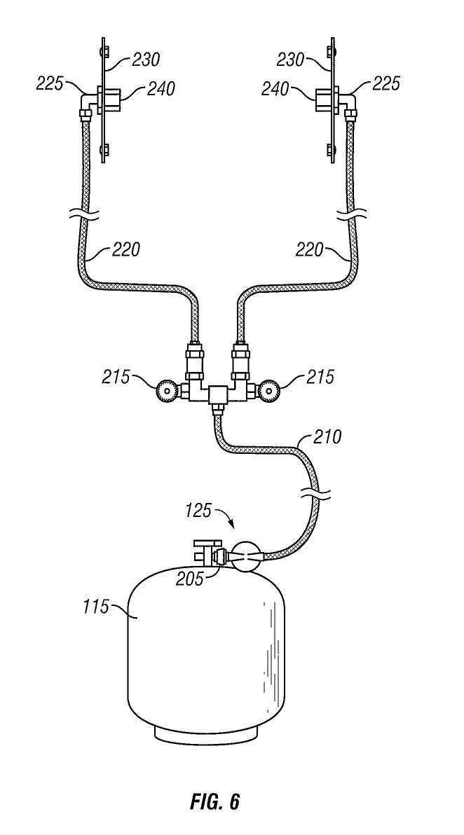

As best viewed in FIG. 6, fuel supply assembly 125 includes a tank coupling 205, a flexible fuel hose or supply line 210, two valves 215, two flexible fuel hoses or supply lines 220, two jet nozzles 225, and two support plates 230. Tank coupling 205 is configured for releasable connection to fuel source 115. Fuel supply line 210 is coupled between tank coupling 205 and valves 215. Each fuel supply line 220 is coupled between one valve 215 and one jet nozzle 225. Valves 215 are actuatable to control or adjust the flow of fuel therethrough. Each nozzle 225 extends through and is supported by one plate 230. Each support plate 230 is configured for coupling to end 170 of one heating conduit 120 such that support plate 230 covers fuel inlet 180 with nozzle 225 extending into heating conduit 120. In the illustrated embodiment shown in FIG. 1, support plates 230 are bolted to flanges 235 extending around the peripheries of heating conduits 120 at ends 170. Moreover, in preferred embodiments, the outlet 240 of each nozzle 225 is disposed 0.5 inches from end 170 of heating conduit 120.

During operation of food cooker 100, fuel source 115 supplies fuel through supply line 210, valves 215, supply lines 220, and nozzles 225 of fuel supply assembly 125 into heating conduits 120 at a desired rate. The rate at which fuel is supplied to heating conduits 120 may be adjusted by actuation of valves 215. In preferred embodiments, the rate at which fuel is supplied to heating conduits 120 is no greater than 2.13 ounces per minute. As previously described, the injected fuel mixes with air inside heating conduits 120. The air-fuel mixture is subsequently ignited and burns. In some embodiments, an end of a handheld butane gas lighter is inserted through one air inlet 185 and actuated to ignite the air-fuel mixture in each heating conduit 120. Heat produced by combustion of the air-fuel mixture is conducted through the wall(s) of heating conduits 120 and then radiated into cooking chamber 105, including food placed on cook grids 150. Periodically, grill hood 145 is opened and the food is flipped or moved relative to cook grids 150. During such movements, the cook remains unexposed to flames which are contained within heating conduits 120, enabling reduced risk to the cook, as compared to that posed by the open flames of conventional gas grills. As the food is heated or cooked, the food remains isolated from fumes within heating conduits 120, also in contrast to conventional gas grills having an open flame.

In the illustrated embodiment, food cooker 100 has two heating conduits 120 supported below two cook grids 150 within cooking chamber 105. In other embodiments, the food cooker may include a different number of cook grids. Similarly, in other embodiments, the food cooker may include a different number of heating conduits. For example, the food cooker may include only a single heating conduit spanning the cooking chamber from end to end. In such embodiments, the fuel supply assembly would be modified accordingly.

While various embodiments have been showed and described, modifications thereof can be made by one skilled in the art without departing from the spirit and teachings herein. The embodiments herein are exemplary only, and are not limiting. Many variations and modifications of the apparatus disclosed herein are possible and within the scope of the invention. Accordingly, the scope of protection is not limited by the description set out above, but is only limited by the claims which follow, that scope including all equivalents of the subject matter of the claims.

What is claimed is:

1. A cooker for preparing food, the cooker comprising:
a cooking chamber; and
a heating conduit extending through the cooking chamber, the heating conduit having an enclosed combustion chamber.

2. The cooker of claim 1, wherein the cooking chamber is formed by a grill body and a grill pivotably coupled thereto.

3. The cooker of claim 1, wherein the heating conduit further comprises a fuel inlet.

4. The cooker of claim 3, further comprising a fuel source in fluid communication with the fuel inlet.

5. The cooker of claim 1, further comprising a fuel supply assembly coupled between a fuel source and the heating conduit, the fuel supply assembly configured to deliver fuel from the fuel source into the heating conduit.

6. The cooker of claim 5, wherein the heating conduit further comprises an air inlet configured to receive air therethrough, the air mixing with the fuel inside the heating conduit.

7. The cooker of claim 6, wherein the fuel inlet has a cross-sectional area and the air inlet has a cross-sectional area, the cross-sectional areas defined in relationship to each other.

8. A cooker for preparing food, the cooker comprising:
a cooking chamber;
a heating conduit extending through the cooking chamber and comprising an enclosed combustion chamber and a fuel inlet; and
a fuel source in fluid communication with the fuel inlet.

9. The cooker of claim 8, further comprising a fuel supply assembly comprising:
a first supply hose coupled between the fuel source and a valve; and
a second supply hose coupled between the valve and a nozzle, wherein the nozzle is at least partially inserted through the fuel inlet;
wherein the valve is actuatable to adjust a flow rate of fuel from the fuel source through the fuel inlet.

10. The cooker of claim 8, further comprising a grill body and a grill hood pivotably coupled thereto, the grill body and the grill hood defining the cooking chamber.

11. The cooker of claim 8, wherein the heating conduit further comprises an exhaust outlet, the exhaust outlet configured to vent fumes from the heating conduit.

12. The cooker of claim 8, further comprising a frame supporting the cooking chamber.

13. The cooker of claim 12, wherein the frame supports the fuel source and is movable.

14. A cooker for preparing food, the cooker comprising:
a cooking chamber; and
a first heating conduit having a first portion extending through the cooking chamber, wherein the first portion comprises an enclosed combustion chamber, and a second portion external to the cooking chamber, wherein the second portion comprises a fuel inlet and an air inlet.

15. The cooker of claim 14, further comprising a grill body and a grill hood pivotably coupled thereto, the grill body and the grill hood defining the cooking chamber.

16. The cooker of claim 15, wherein the grill body supports the first heating conduit.

17. The cooker of claim 14, further comprising a second heating conduit having a first portion extending through the cooking chamber, wherein the first portion comprises an enclosed combustion chamber, and a second portion external to the cooking chamber, wherein the second portion comprises a fuel inlet and an air inlet.

18. The cooker of claim 17, further comprising a fuel source in fluid communication with the first heating conduit and the second heating conduit.

19. The cooker of claim 18, further comprising a fuel supply assembly comprising:
a first supply hose coupled between the fuel source and a first valve and a second valve;
a second supply hose coupled between the first valve and a first nozzle, wherein the first nozzle is at least partially inserted through the fuel inlet of the first heating conduit;
a third supply hose coupled between the second valve and a second nozzle, wherein the second nozzle is at least partially inserted through the fuel inlet of the second heating conduit;
wherein the first valve is actuatable to adjust a flow rate of fuel from the fuel source through the fuel inlet of the first heating conduit; and
wherein the second valve is actuatable to adjust a flow rate of fuel from the fuel source through the fuel inlet of the second heating conduit.

20. The cooker of claim 14, further comprising a wheeled frame and a support post coupled between the wheeled frame and the cooking chamber, whereby the cooker is mobile.

21. The cooker of claim 20, wherein the fuel source is a portable tank comprising one of liquid propane and natural gas and supported by the wheeled frame.
